(19) United States
(12) Patent Application Publication
(10) Pub. No.: US 2019/0210598 A1
(43) Pub. Date: Jul. 11, 2019

(54) VEHICLE DRIVING ASSISTANCE APPARATUS AND VEHICLE DRIVING ASSISTANCE METHOD

(71) Applicant: MITSUBISHI ELECTRIC CORPORATION, Chiyoda-ku, Tokyo (JP)

(72) Inventor: Masaya ENDO, Chiyoda-ku (JP)

(73) Assignee: MITSUBISHI ELECTRIC CORPORATION, Chiyoda-ku, Tokyo (JP)

(21) Appl. No.: 16/303,276

(22) PCT Filed: Jun. 21, 2016
(86) PCT No.: PCT/JP2016/068393

§ 371 Date: Nov. 20, 2018

(51) Int. Cl. B60W 30/12; B62D 6/00; B62D 15/02; G08G 1/16

(52) U.S. Cl. CPC B60W 30/12; B62D 6/002; B60W 10/20; G08G 1/166; B62D 15/025

(57) ABSTRACT

This vehicle driving support device includes: a state acquisition device configured to acquire a detection result from a state detector configured to detect a travel state and a steering state of a vehicle; a target path information acquisition device configured to acquire target path information indicating a path on which the vehicle is to travel; a prediction device configured to predict a deviation of a position of the vehicle from the target path information, and a twist amount of the steering shaft; and a calculator configured to calculate a target amount of a steering controller configured to control the motor based on the deviation of the position of the vehicle from the target path information and the twist amount of the steering shaft so as to reduce the twist amount of the steering shaft.

### TECHNICAL FIELD

The present invention relates to a vehicle driving support device and a vehicle driving support method, for supporting driving of a vehicle by a driver.

### BACKGROUND ART

Hitherto, there has been known a vehicle driving support device configured to correct steering by a driver so as to cause a vehicle to follow a target path. As such a vehicle driving support device, there is disclosed a travel support device including: state acquisition means for acquiring a travel state and a steering state; trajectory prediction means for predicting a travel trajectory of the vehicle after a current time point based on the state results acquired by the state acquisition means; correction amount calculation means for calculating a correction amount for correcting the steering state so as to reduce a lateral error between a target trajectory and the travel trajectory predicted by the trajectory prediction means; and correction amount output means for outputting the correction amount to state correction means, in which the travel support device is configured to repeat this processing periodically (for example, refer to Patent Literature 1).

With this travel support device, the trajectory prediction means uses a state equation of the vehicle, which is a vehicle motion model, and the correction amount of the steering state that minimizes a cost function of the lateral error is calculated to suppress a sudden change in a vehicle behavior, to thereby achieve smooth steering feeling that does not cause the driver to feel a sense of discomfort while reducing the lateral error of the vehicle to suppress departure of the vehicle from a lane.

### CITATION LIST

### Patent Literature

[PTL 1] JP 2010-126077 A

### SUMMARY OF INVENTION

### Technical Problem

However, with the travel support device disclosed in Patent Literature 1, the target path suddenly changes under such a state as an emergency avoidance state, in which an obstacle that abruptly appears is to be avoided, and thus the vehicle behavior may also suddenly change.

In particular, in automatic steering based on electric power steering, when a sudden change in target path is tried to be followed, a twist may occur in a steering shaft due to an impact caused by the automatic steering, with the result that a steering wheel vibrates and the driver feels a sense of discomfort.

Further, the twist in the steering shaft due to the impact maybe detected by a steering torque sensor in the electric power steering, and it may be determined that steering intervention by the driver has occurred, with the result that the automatic steering stops.

The present invention has been made in view of the above-mentioned problem, and therefore has an object to provide a vehicle driving support device and a vehicle driving support method, which are capable of suppressing vibration of a steering wheel caused by impact of automatic steering, and preventing erroneous determination of steering intervention by a driver.

### Solution to Problem

According to one embodiment of the present invention, there is provided a vehicle driving support device including: a state acquisition device configured to acquire a detection result from a state detector configured to detect a travel state and a steering state of a vehicle; a target path information acquisition device configured to acquire target path information indicating a path on which the vehicle is to travel; a prediction device configured to use a vehicle motion model describing a motion of the vehicle, and a steering-shaft motion model describing a motion of a steering shaft configured to couple a steering wheel and a motor configured to support steering of the vehicle to each other, to thereby predict a deviation of a position of the vehicle from the target path information, and a twist amount of the steering shaft; and a calculator configured to calculate a target amount of a steering controller configured to control the motor based on the deviation of the position of the vehicle from the target path information and the twist amount of the steering shaft so as to reduce the twist amount of the steering shaft.

Further, according to one embodiment of the present invention, there is provided a vehicle driving support method to be achieved by a vehicle driving support device configured to support driving of a vehicle, the vehicle driving support method including: a state acquisition step of acquiring a detection result from a state detection device configured to detect a travel state and a steering state of the vehicle; a target path information acquisition step of acquiring target path information indicating a path on which the vehicle is to travel; a prediction step of using a vehicle motion model describing a motion of the vehicle, and a steering-shaft motion model describing a motion of a steering shaft configured to couple a steering wheel and a motor configured to support steering of the vehicle to each other, to thereby predict a deviation of a position of the vehicle from the target path information, and a twist amount of the steering shaft; and a calculation step of calculating a target amount of a steering controller configured to control the motor based on the deviation of the position of the vehicle from the target path information and the twist amount of the steering shaft so as to reduce the twist amount of the steering shaft.

### Advantageous Effects of Invention

With the vehicle driving support device and the vehicle driving support method according to the embodiments of the present invention, the vehicle motion model describing the motion of the vehicle and the steering-shaft motion model describing the motion of the steering shaft configured to couple the steering wheel and the motor configured to support the steering of the vehicle to each other are used to predict the deviation of the position of the vehicle from the target path information and the twist amount of the steering shaft, and the target amount of the steering controller configured to control the motor is calculated based on the deviation of the position of the vehicle from the target path information and the twist amount of the steering shaft so that the twist amount of the steering shaft is reduced.

Therefore, it is possible to suppress the vibration of the steering wheel caused by the impact of the automatic steering, and to prevent the erroneous determination of the steering intervention by the driver.

### BRIEF DESCRIPTION OF DRAWINGS

FIG. 1 is a block configuration diagram for illustrating a vehicle driving support device according to a first embodiment of the present invention.

FIG. 2 is a configuration diagram for illustrating the vehicle driving support device according to the first embodiment of the present invention together with peripheral devices.

FIG. 3 is a flowchart for illustrating an operation of the vehicle driving support device according to the first embodiment of the present invention.

FIG. 4 is a block configuration diagram for illustrating a principal part of the vehicle driving support device according to the first embodiment of the present invention.

FIG. 5 is a graph for showing a relationship between a ground-fixed coordinate system and target path information in the vehicle driving support device according to the first embodiment of the present invention.

FIG. 6 is a block configuration diagram for illustrating a steering controller connected to the vehicle driving support device according to the first embodiment of the present invention.

FIG. 7 is a graph for showing an effect of the vehicle driving support device according to the first embodiment of the present invention.

FIG. 8 is a graph for showing the effect of the vehicle driving support device according to the first embodiment of the present invention.

### DESCRIPTION OF EMBODIMENTS

A description is now given of a vehicle driving support device and a vehicle driving support method according to preferred embodiments of the present invention with reference to the accompanying drawings, and throughout the drawings, like or corresponding components are denoted by like reference symbols to describe those components.

### First Embodiment

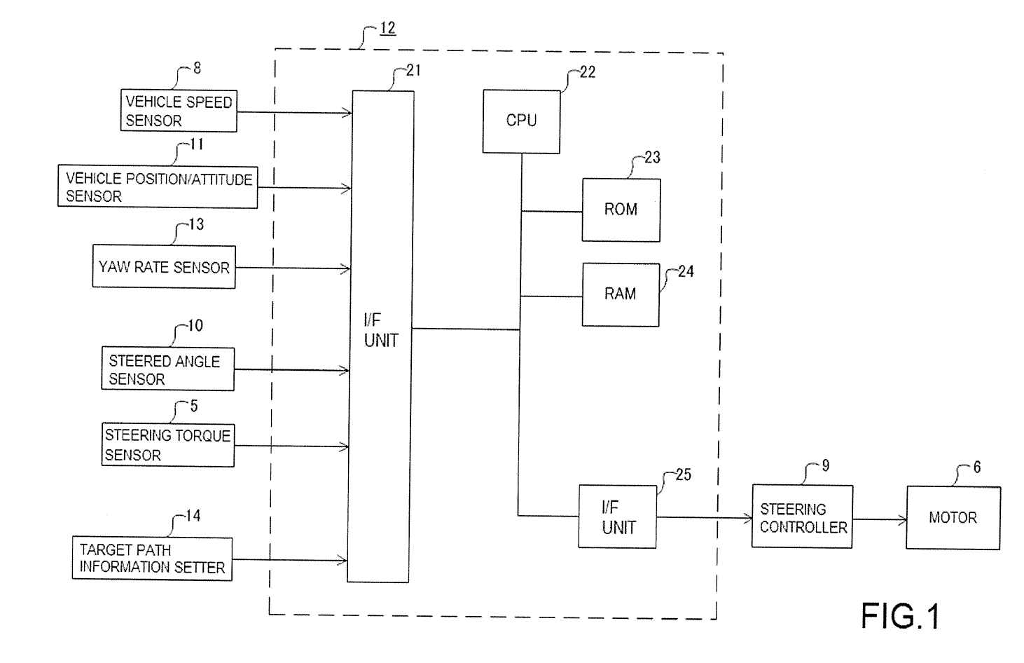

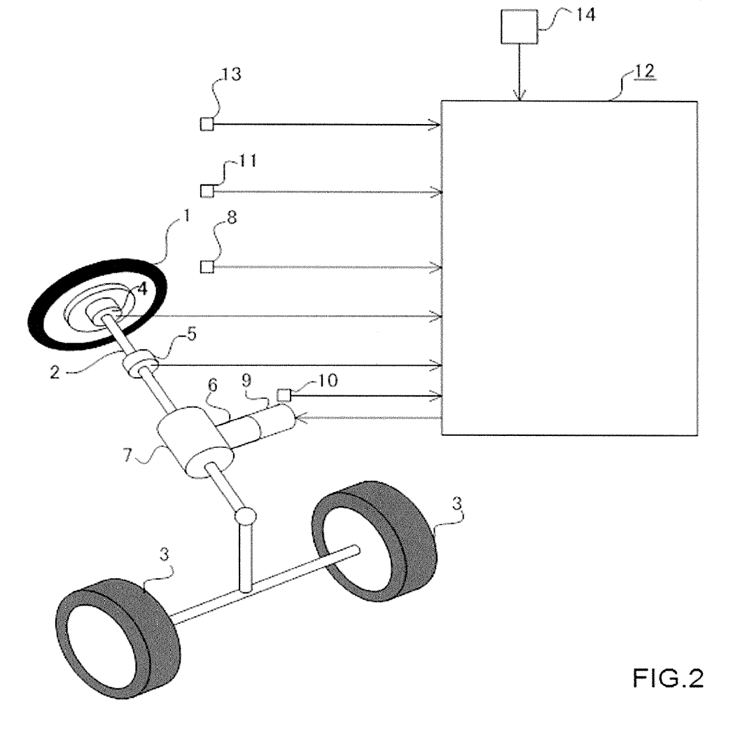

FIG. 1 is a block configuration diagram for illustrating a vehicle driving support device according to a first embodiment of the present invention. Moreover, FIG. 2 is a configuration diagram for illustrating the vehicle driving support device according to the first embodiment of the present invention together with peripheral devices.

In FIG. 1 and FIG. 2, the vehicle driving support device 12 is configured to acquire information from various sensors and the like configured to detect a travel state and a steering state of the vehicle, calculate a target value of a steering controller 9 configured to support the driving of the vehicle, and output the calculated target value to the steering controller 9.

Moreover, the vehicle driving support device 12 has a microcomputer. The microcomputer includes a CPU 22 and a memory. The CPU 22 is configured to carry out calculation processing required to calculate the target value. The memory includes a ROM 23 and a RAM 24.

Moreover, a steering mechanism of a vehicle, for example, a motor vehicle, includes a steering wheel 1 and a steering shaft 2. Left and right steered wheels 3 of the vehicle are steered in accordance with rotation of the steering shaft 2 caused by an operation of the steering wheel 1 by a driver.

Moreover, a steering torque sensor 5 is arranged in the steering shaft 2. A steering torque by the driver acting on the steering shaft 2 via the steering wheel 1 is detected by the steering torque sensor 5.

In this example, a part of the steering shaft 2 is constructed of a torsion bar. The steering torque sensor 5 generates a signal in accordance with a torsion angle of the torsion bar of the steering shaft 2. A steering torque received by the steering shaft 2 from the driver is acquired based on a signal from the steering torque sensor 5.

The motor 6 is coupled to the steering shaft 2 via a speed reduction mechanism 7. A current flowing through the motor 6 is controlled by the steering controller 9 so that a steering assist torque generated by the motor 6 can be applied to the steering shaft 2.

Moreover, a motor rotation angle sensor configured to detect a rotation angle of the motor 6 is provided in the motor 6. In the first embodiment, the quotient of the rotation angle detected by the motor rotation angle sensor divided by a speed reduction ratio of the speed reduction mechanism 7 is set as a steered angle, and the motor rotation angle sensor is used as a steered angle sensor 10.

In the vehicle, a vehicle speed sensor 8, a vehicle position/attitude sensor 11, and a yaw rate sensor 13 are provided. The vehicle speed sensor 8 is configured to detect a travel speed of the vehicle. The vehicle position/attitude sensor 11 is configured to detect a travel position and attitude of the vehicle. The yaw rate sensor 13 is configured to detect a rotation angular velocity of the vehicle. The travel speed of the vehicle is hereinafter referred to as “vehicle speed”. Moreover, the vehicle is provided with a target path information setter 14 configured to set target path information indicating a path on which the vehicle is to travel.

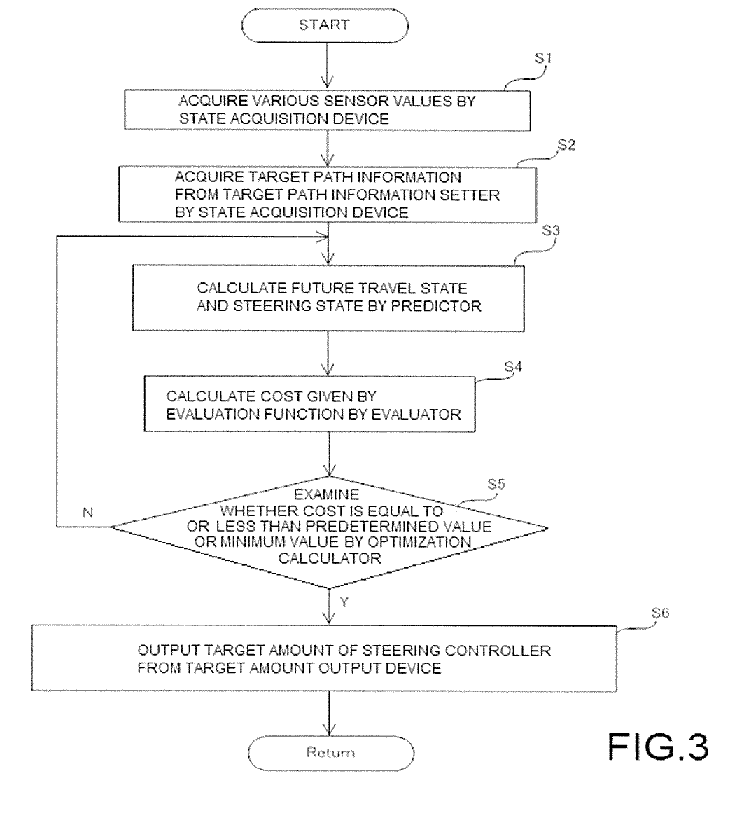

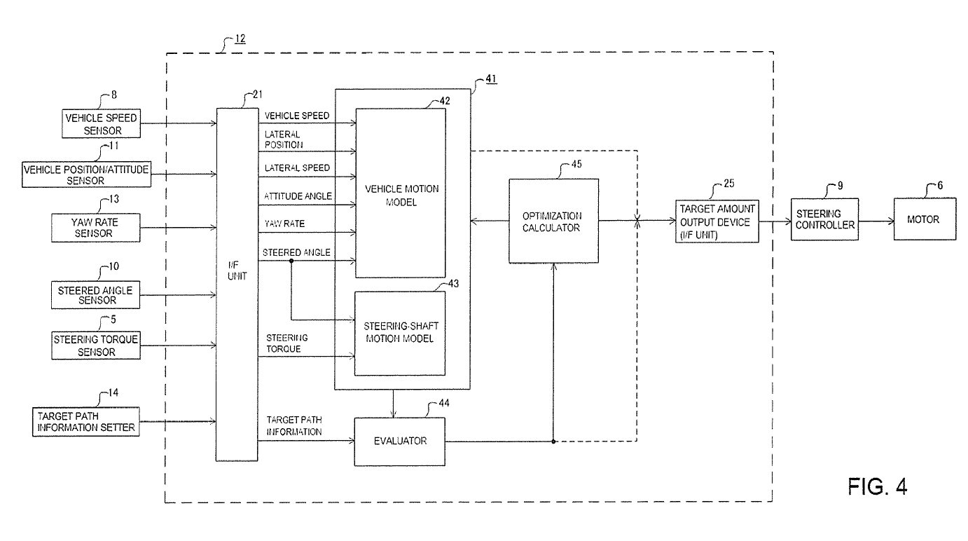

With reference to FIG. 3 and FIG. 4 together with FIG. 1 and FIG. 2, a description is now given of an operation and calculation processing of the vehicle driving support device 12, which is a principal part of the present invention. FIG. 3 is a flowchart for illustrating the operation of the vehicle driving support device according to the first embodiment of the present invention. FIG. 4 is a block configuration diagram for illustrating a principal part of the vehicle driving support device according to the first embodiment of the present invention.

The operation illustrated in the flowchart of FIG. 3 is repeated at a control cycle of a predetermined period set in advance. In the first embodiment, a control cycle Ts of the predetermined period is 50 milliseconds.

First, detection values obtained by the respective sensors are acquired by an I/F unit 21 of FIG. 1, which is a state acquisition device (Step S1).

In the first embodiment, a vehicle speed V of the vehicle detected by the vehicle speed sensor 8, a displacement y in a Y-axis direction of the vehicle, and a speed

\dot{y}

and an attitude angle θ of the vehicle, which are detected by the vehicle position/attitude sensor 11, a yaw rate

\dot{θ}

of the vehicle detected by the yaw rate sensor 13, a steered angle δₚ detected by the steered angle sensor 10, and a steering torque detected by the steering torque sensor 5 are taken into the RAM 24 of the vehicle driving support device 12 via the I/F unit 21.

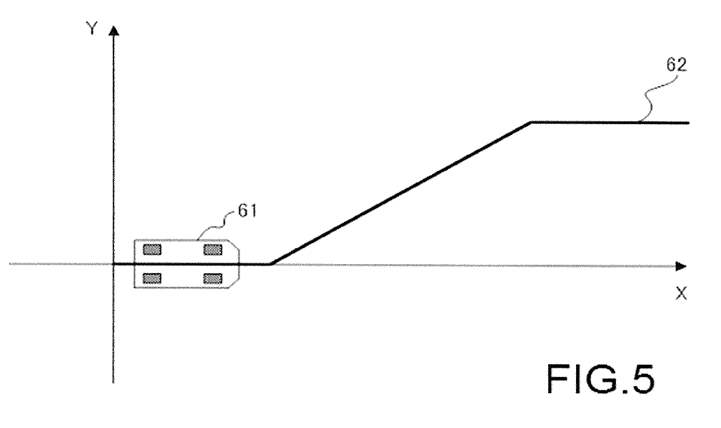

As a coordinate system in the first embodiment, a ground-fixed coordinate system is used as shown in FIG. 5. FIG. 5 is a graph for showing a relationship between the ground-fixed coordinate system and the target path information in the vehicle driving support device according to the first embodiment of the present invention.

Subsequently, target path information indicating a path on which the vehicle is to travel is acquired from the target path information setter 14 by the I/F unit 21 of FIG. 1, which is a target path information acquisition device (Step S2). In this case, as shown in FIG. 5, the target path information is, for example, coordinates indicating the target travel path in the ground-fixed coordinate system. Moreover, the target path shown in FIG. 5 indicates a lane change to a left lane.

Then, a future travel state and a future steering state are calculated by a predictor 41 through use of the acquired respective pieces of sensor information and the acquired target path information (Step S3). The predictor 41 includes a vehicle motion model 42 and a steering-shaft motion model 43. The vehicle motion model 42 describes a motion of the vehicle to be used to predict the travel state of the vehicle. The steering-shaft motion model 43 describes a motion of the steering shaft to be used to predict the steering state of the steering shaft.

As the vehicle motion model 42, for example, a two-wheel model described in the ground-fixed coordinate system is used. Equations of motion can be described as Expression (1) and Expression (2).

$$\begin{matrix}m \frac{{d}^{2} y}{{d}^{2} t} + \frac{2 ( {K}_{f} + {K}_{r} )}{V} \frac{dy}{dt} + \frac{2 ( {l}_{f} {K}_{f} - {l}_{r} {K}_{r} )}{V} \frac{d θ}{dt} - 2 ( {K}_{f} + {K}_{r} ) θ = 2 {K}_{f} \frac{{δ}_{p}}{{G}_{rp}} & ( 1 ) \\ \frac{2 ( {l}_{f} {K}_{f} - {l}_{r} {K}_{r} )}{V} \frac{dy}{dt} + \frac{{I}_{z} ( {d}^{2} θ )}{{d}^{2} t} + \frac{2 ( {l}_{r}^{2} {K}_{f} + {l}_{r}^{2} {K}_{r} )}{V} \frac{d θ}{dt} - 2 ( {l}_{f} {K}_{f} - {l}_{r} {K}_{r} ) θ = 2 {l}_{f} {K}_{f} \frac{{δ}_{p}}{{G}_{rp}} & ( 2 )\end{matrix}$$

In Expression (1) and Expression (2), the parameters are shown in Table 1.

TABLE 1

| | |
|---|---|
| m | Vehicle weight |
| K_{f} | Front wheel cornering power |
| Kᵣ | Rear wheel cornering power |
| L_{f} | Distance from center of gravity to front wheel axle |
| Lᵣ | Distance from center of gravity to rear wheel axle |
| I_{z} | Vehicle body moment of inertia |
| Gᵣₚ | Overall steering gear ratio |

A description is now given of the steering-shaft motion model 43. The steering shaft 2 couples the steering wheel 1 to the motor 6 and the steered wheels 3 connected via the speed reducer 7. Torsional rigidity of the steering shaft 2 is indicated by Kₜₛₑₙₛ. A viscosity coefficient of the steering shaft 2 is indicated by Cₜₛₑₙₛ. Moreover, the steering-shaft motion model 43 can be described as Expression (3).

$${J}_{h} \frac{{d}^{2} {δ}_{h}}{{d}^{2} t} = - {K}_{tsens} ( {δ}_{h} - {δ}_{p} ) - {C}_{tsens} ( \frac{d {δ}_{h}}{dt} - \frac{d {δ}_{p}}{dt} ) \qquad ( 3 )$$

Moreover, the steering torque sensor 5 is configured to detect a torque acting on the steering shaft 2 from a torsion amount of the steering shaft 2. The steering torque Tₛₑₙₛ detected by the steering torque sensor 5 is modeled by Expression (4).

$${T}_{sens} = {K}_{tsens} ( {δ}_{h} - {δ}_{p} ) \qquad ( 4 )$$

In this case, a state variable x is given by Expression (5).

$$x = [ \begin{matrix}{δ}_{p} \\ y \\ \dot{y} \\ θ \\ \dot{θ} \\ {δ}_{h} \\ {\dot{δ}}_{h}\end{matrix} ] \qquad ( 5 )$$

Expression (1) to Expression (3) can be converted to state equations given by Expression (6) and Expression (7).

\dot{x}=A_{c}x+B_{c}u (6)

z=C_{c}x+D_{c}u (7)

The values of Expression (6) and Expression (7) are given by Expression (8) to Expression (11).

$$\begin{matrix}{A}_{c} = [ \begin{matrix}0 & 0 & 0 & 0 & 0 & 0 & 0 \\ 0 & 0 & 1 & 0 & 0 & 0 & 0 \\ \frac{2 {K}_{f}}{m} & 0 & \frac{- 2 ( {K}_{f} + {K}_{r} )}{mV} & \frac{2 ( {K}_{f} + {K}_{r} )}{m} & \frac{- 2 ( {l}_{f} {K}_{f} - {l}_{r} {K}_{r} )}{mV} & 0 & 0 \\ 0 & 0 & 0 & 0 & 1 & 0 & 0 \\ \frac{2 {l}_{f} {K}_{f}}{{I}_{z}} & 0 & \frac{- 2 ( {l}_{f} {K}_{f} - {l}_{r} {K}_{r} )}{{I}_{z} V} & \frac{2 ( {l}_{f} {K}_{f} - {l}_{r} {K}_{r} )}{{I}_{z}} & \frac{- 2 ( {l}_{f}^{2} {K}_{f} + {l}_{r}^{2} {K}_{r} )}{{I}_{z} V} & 0 & 0 \\ 0 & 0 & 0 & 0 & 0 & 0 & 1 \\ \frac{{K}_{tsens}}{{J}_{h}} & 0 & 0 & 0 & 0 & - \frac{{K}_{tsens}}{{J}_{h}} & - \frac{{C}_{tsens}}{{J}_{h}}\end{matrix} ] & ( 8 ) \\ {B}_{c} = [ \begin{matrix}1 \\ 0 \\ 0 \\ 0 \\ 0 \\ 0 \\ \frac{{C}_{tsens}}{{J}_{h}}\end{matrix} ] & ( 9 ) \\ {C}_{c} = {E}_{7} & ( 10 ) \\ {D}_{c} = [ \begin{matrix}0 \\ 0 \\ 0 \\ 0 \\ 0 \\ 0 \\ 0\end{matrix} ] & ( 11 )\end{matrix}$$

An input u to the vehicle motion model and the steering-shaft motion model given by the state equations is a steered angular velocity given by Expression (12).

u=δₚ (12)

Moreover, difference equations obtained by discretization at the control cycle Ts are given by Expression (13) and Expression (14).

x[k+1]=A_{d}x[k]+B_{d}u[k] (13)

z[k+1]=C_{d}x[k]+D_{d}u[k] (14)

The predictor 41 uses the vehicle motion. model and the steering-shaft motion model described in Expression (13) and Expression (14), respectively, and a current travel state

(δₚ,y,\dot{y},θ,\dot{θ})

and a current steering state

(δₕ,\dot{δ}ₕ)

acquired by the various sensors as an initial value x[1], and uses inputs from u[1] to u[N] corresponding to the number N of prediction steps and received from an optimization calculator 45 described later to predict future travel states and steering states ranging from x[1] to x[1+N].

For example, when N=20, Ts is 50 milliseconds, and thus states up to one second later are predicted. In this case, an initial value of δₕ is calculated from the detected steered angle δₚ and the detected steering torque Tₛₑₙₛ through use of Expression (4). Moreover,

\dot{δ}ₕ

is calculated by differentiating δₕ.

Then, an evaluator 44 sets a cost function J so as to calculate a cost (Step S4). In the first embodiment, the cost function J is set as given by Expression (15).

J=Σₖ₌₁^{N+1}Q_{y}(y[k]−y_{ref}[k])²+Q_{T}(δₚ[k]−δₕ[k])²+Ru[k]² (15)

The first term on the right side of Expression (15) is a term for reducing a deviation between a target path at a future time point corresponding to the N prediction steps and a predicted vehicle path. Moreover, the second term on the right side is a term for reducing a twist amount of the steering shaft 2 at the future time point corresponding to the N prediction steps. Moreover, the third term on the right side is a term for reducing the input, which is the steered angular velocity

\dot{δ}ₚ

at the future time point corresponding to the N prediction steps. Q_{y}, Q_{T}, and R are weights of the respective terms.

Then, the optimization calculator 45 examines whether or not the calculated cost is equal to or less than a predetermined value set in advance or is the minimum value (Step S5).

When it is determined in Step S5 that the calculated cost is equal to or less than the predetermined value or is the minimum value (that is, Yes), u[1] to u[N] are set as optimal input values that optimize, at this sampling time point, the cost function J at the future time point corresponding to the N prediction steps.

On the other hand, when it is determined in Step S5 that the calculated cost is not equal to or less than the predetermined value or is not the minimum value (that is, No), u[1] to u[N] are changed so as to reduce the cost J, and the processing from Step S3 to Step S5 is repeated until the cost becomes equal to or less than the predetermined value or the minimum value.

The calculation in Step S3 to Step S5 is a solution for the so-called optimization problem, and known various methods can be used for the calculation.

Then, the I/F unit 25 of FIG. 1, which is a target amount output device, outputs a target amount of the steering controller to the steering controller 9 (Step S6). In this case, the target amount of the steering controller 9 is a target angle δ_{ref} of the steered angle of the steering shaft 2, and is set to δₚ[2] from a result calculated by the predictor 41. δₚ[2] is a steered angle in the first predicted step.

The vehicle driving support device 12 repeats Step S1 to Step S6 described above at the control cycle Ts of the predetermined period.

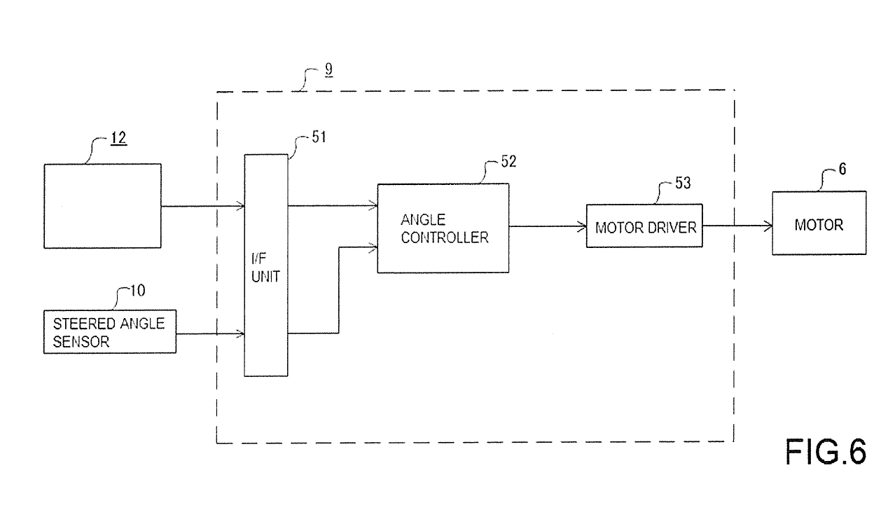

Referring to FIG. 6, a description is now given of an operation of the steering controller 9. FIG. 6 is a block configuration diagram for illustrating the steering controller connected to the vehicle driving support device according to the first embodiment of the present invention.

In FIG. 6, the steering controller 9 acquires the target angle δ_{ref} output from the vehicle driving support device 12 and the steered angle δₚ detected by the steered angle sensor 10 via an I/F unit 51.

An angle controller 52 is configured to calculate, from the acquired target angle δ_{ref} and the steered angle δₚ, a target current required to flow through the motor 6 so that the steered angle δₚ follows the target angle δ_{ref}. A motor driver 53 is configured to control a current so that the target current calculated by the angle controller 52 flows through the motor 6.

The angle controller 52 can apply various known types of control, for example, PID control that is based on a deviation between the target angle δ_{ref} and the steered angle δₚ.

With the above-mentioned configuration, the steering shaft 2, namely, the steering wheel 1, can be steered by the motor 6 so that the steered angle δₚ follows the target angle δ_{ref} calculated by the vehicle driving support device 12.

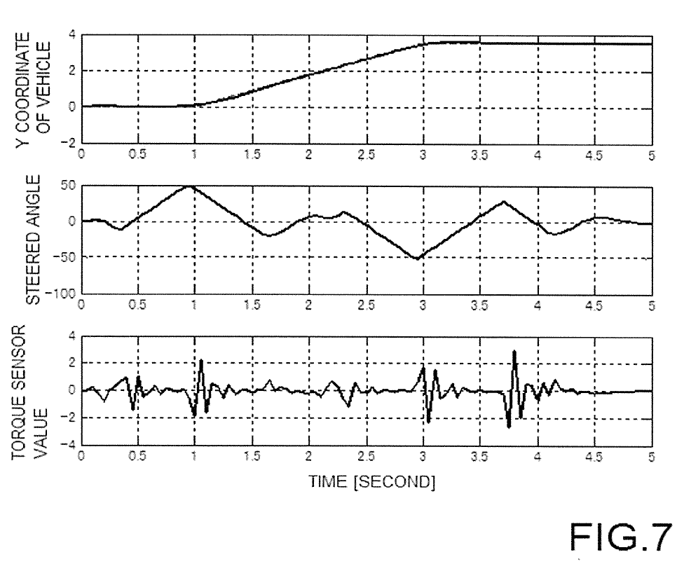

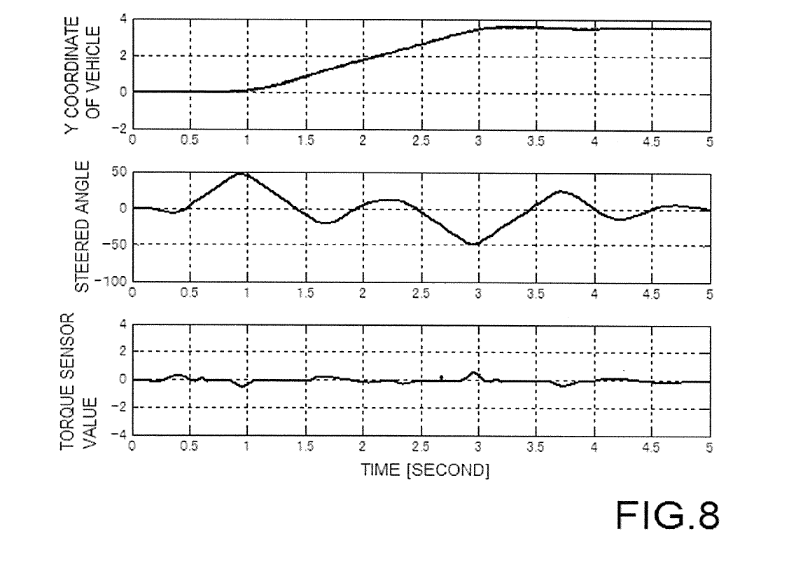

Next, referring to FIG. 7 and FIG. 8, a description is now given of effects of the first embodiment. FIG. 7 and FIG. 8 are graphs for showing the effects of the vehicle driving support device according to the first embodiment of the present invention.

Moreover, FIG. 7 is a graph for showing a simulation result obtained when the second term on the right side is set to zero in Expression (15). FIG. 8 is a graph for showing a simulation result obtained when the second term on the right side is used in Expression (15). Scales of the vertical axes of FIG. 7 and FIG. 8 are the same, and the target path is a path for a lane change of 3.5 meters in 2 seconds.

First, both in FIG. 7 and FIG. 8, the predictor 41 is used to carry out the sequential control so as to optimize the cost function, and thus it is appreciated that the target path is followed equivalently excellently. Moreover, the predictor 41 is used, and thus it is appreciated that the steered angle δₚ is controlled before the target path changes at a time point of one second. As a result, the target path is followed excellently.

However, in the result shown in FIG. 7, in which the twist amount of the steering shaft 2 is not added to the cost function, it is appreciated that the steered angle δₚ suddenly changes at some portions, and a variation in detection value of the steering torque sensor 5 is large. This state is equivalent to a state in which the twist amount (δₕ−δₚ) of the steering shaft 2 is large.

In this case, in automatic steering based on electric power steering, when the sudden change in target path is tried to be followed, a twist may occur in the steering shaft due to an impact by the automatic steering, with the result that the steering wheel 1 vibrates and the driver feels a sense of discomfort.

In contrast, in the result of FIG. 8, in which the twist amount of the steering shaft 2 is added to the cost function, it is appreciated that the variation in detection value of the torque sensor is suppressed to be small. This is because the target value of the steering controller is calculated so as to reduce the cost function, and the target value of the steered angle δₚ is set so that the twist amount of the steering shaft 2 is less likely to occur. Moreover, as shown in the second row of FIG. 8, it is appreciated that a change in steered angle δₚ is smoother than that of the second row of FIG. 7.

In this manner, the vibration of the steering wheel 1 can be suppressed to achieve smoother automatic steering causing less sense of discomfort by using the steering-shaft motion model describing the motion of the steering shaft 2 to predict the steering state including at least the future twist amount of the steering shaft 2, and calculating the target amount of the steering controller 9 so as to reduce the predicted twist amount of the steering shaft 2.

Further, as a technology relating to the automatic steering, there is known an overriding technology of prioritizing the steering of the driver when a direction of the automatic steering and a direction of the steering intended by the driver are different from each other. In this overriding technology, in general, when an absolute value detected by the steering torque sensor 5 is large, the driver is determined to be intervening in the steering, and the automatic steering is switched to manual driving by the driver.

Therefore, in the graph of FIG. 7, in which the twist amount of the steering shaft 2 is not added to the cost function, even when the driver is not intervening during the automatic steering, an increase in detection value of the steering torque sensor 5 may be erroneously determined as the steering intervention by the driver, and the switching to the manual operation may occur.

In contrast, with the configuration of the first embodiment, the detection value of the steering torque sensor 5 can be suppressed to be small, and the discrimination from the steering intervention by the driver becomes easy. Thus, the erroneous determination can be prevented, and smoother automatic steering causing less sense of discomfort can consequently be achieved.

Further, when the twist amount is not added to the cost function and the driver actually intervenes in the steering, the target steered angle that prioritizes following of the target path is calculated, and it is difficult for the driver to intervene in the steering unless the override function is provided.

In contrast, when the twist amount is added to the cost function, and the twist amount of the steering shaft 2 is increased by the steering intervention by the driver, the target steered angle is calculated in consideration of reduction of the twist amount, and thus the driver is enabled to intervene in the steering. This achieves smoother overriding in a case where the override function is installed.

Moreover, the use of the ground-fixed coordinate system eliminates necessity to convert the coordinates during the iterative calculation for solving the optimization problem, resulting in reduction in calculation load.

As described above, according to the first embodiment, the vehicle motion model describing the motion of the vehicle and the steering-shaft motion model describing the motion of the steering shaft configured to couple the steering wheel and the motor configured to support the steering of the vehicle to each other are used to predict the deviation of the position of the vehicle from the target path information and the twist amount of the steering shaft. Further, the target amount of the steering controller configured to control the motor is calculated based on the deviation of the position of the vehicle from the target path information and the twist amount of the steering shaft so that the twist amount of the steering shaft is reduced.

Therefore, the vibration of the steering wheel caused by the impact of the automatic steering can be suppressed, and the erroneous determination of the steering intervention by the driver can be prevented.

Moreover, the calculator includes the evaluator configured to calculate the cost function formed of the deviation of the position of the vehicle from the target path information and the twist amount of the steering shaft predicted by the predictor, and the optimization calculator configured to calculate the steered angle of the steering shaft at least required to cause the cost function to converge to a value equal to or less than the value set in advance or the minimum value through the convergence calculation using the predictor and the evaluator.

In other words, the twist amount of the steering shaft can be suppressed by including the twist amount of the steering shaft in the cost function in consideration of the steering-shaft motion model to suppress the vibration of the steering wheel, and thus smoother automatic steering causing less sense of discomfort can be achieved.

In the first embodiment, the motor rotation angle sensor is used as the steered angle sensor 10. However, an angle sensor may independently be provided between the steering torque sensor 5 of the steering shaft 2 and the steered wheels 3.

The target path information setter 14 may be provided in the vehicle driving support device 12. For example, a camera configured to detect white lines may be provided, and the target path information may be calculated from white line information detected by the camera in the target path information setter 14.

Moreover, the vehicle motion model and the steering-shaft motion model are not limited to the above-mentioned models, and may be models closer to the actual machine.

Moreover, in the first embodiment, a steering angle sensor configured to detect a steering angle is not used. However, a steering angle sensor 4 mounted to the steering wheel 1 of FIG. 2 may be used to detect the steering angle δₕ, and the twist amount of the steering shaft 2 may be calculated from a difference between the steering angle sensor 4 and the steered angle sensor 10.

### Second Embodiment

A description is now given of a second embodiment of the present invention. Regarding configurations common to the first and second embodiments, the same names, reference numerals, and signs are used, and differences from the first embodiment are described.

In the first embodiment described above, the term of the twist amount is included in the cost function J of the evaluator 44, but, in the second embodiment, the term of the twist amount is not included, and the minimum value and the maximum value of the twist amount or the steering torque are set as a constraint condition.

Moreover, u[1] to u[N] are calculated through the iterative calculation in Step S3 to Step S5 so that the cost function J is equal to or less than a predetermined value or is the minimum value in a range in which Expression (16) is satisfied.

Tₛₑₙₛ_{_}ₘᵢₙ≤Kₜₛₑₙₛ(δₚ−δₕ)≤Tₛₑₙₛ_{_}ₘₐₓ (16)

In Expression (16), Tₛₑₙₛ_{_}ₘᵢₙ is a negative value, and has the same magnitude as Tₛₑₙₛ_{_}ₘₐₓ. For example, the magnitude of Tₛₑₙₛ_{_}ₘₐₓ is set to 1 Nm.

As a result, the steering torque variation generated in FIG. 7 can be reduced. Moreover, when the driver steers the steering wheel 1, the target angle δ_{ref} that reduces the cost function J in the range in which the steering torque detected by the steering torque sensor 5 is suppressed to be 1 Nm is calculated.

Moreover, through setting of a threshold for the steering torque used to determine the intervention by the driver in the overriding to a value equal to or higher than Tₛₑₙₛ_{_}ₘₐₓ, smooth transition to the manual driving can be achieved when the magnitude of the steering torque is equal to or higher than Tₛₑₙₛ_{_}ₘₐₓ.

In this manner, the vibration of the steering wheel 1 can be suppressed, and the problem of the erroneous determination of the steering intervention by the driver can be prevented to achieve smoother automatic steering causing less sense of discomfort by using the steering-shaft motion model describing the motion of the steering shaft 2 to predict the steering state including at least the future twist amount of the steering shaft 2, and calculating the target amount of the steering controller 9 so as to reduce the predicted twist amount of the steering shaft 2.

As described above, according to the second embodiment, the vehicle motion model describing the motion of the vehicle and the steering-shaft motion model describing the motion of the steering shaft configured to couple the steering wheel and the motor configured to support the steering of the vehicle to each other are used to predict the deviation of the position of the vehicle from the target path information and the twist amount of the steering shaft. Further, the target amount of the steering controller configured to control the motor is calculated based on the deviation of the position of the vehicle from the target path information and the twist amount of the steering shaft so that the twist amount of the steering shaft is reduced.

Therefore, the vibration of the steering wheel caused by the impact of the automatic steering can be suppressed, and the erroneous determination of the steering intervention by the driver can be prevented.

Moreover, the calculator includes the evaluator configured to calculate the cost function formed of the deviation of the position of the vehicle from the target path information predicted by the predictor and the constraint condition relating to the twist amount of the steering shaft predicted by the predictor, and the optimization calculator configured to calculate the steered angle of the steering shaft at least satisfying the constraint condition, and required to cause the cost function to converge to a value equal to or less than the value set in advance or the minimum value through convergence calculation using the predictor and the evaluator.

In other words, the twist amount of the steering shaft can be suppressed by including the twist amount of the steering shaft in the constraint condition in consideration of the steering-shaft motion model to suppress the vibration of the steering wheel, and thus smoother automatic steering causing less sense of discomfort can be achieved.

In the second embodiment, the configuration in which the twist amount is not included in the cost function is described, but the configuration is not limited to this example. For example, both Expression (15) and Expression (16) may be used to calculate u[1] to u[N] through the iterative calculation from Step S3 to Step S5.

As a result, the twist amount of the steering shaft 2 can be reduced during the automatic steering, and when the driver performs steering, u[1] to u[N] are calculated so that the magnitude of the steering torque is suppressed to be equal to or lower than Tₛₑₙₛ_{_}ₘₐₓ and thus interference with the steering intervention by the driver can be suppressed. The constraint condition may be set for other state quantities, for example, the yaw rate.

### Third Embodiment

A description is now given of a third embodiment of the present invention. Regarding configurations common to the first and third embodiments, the same names, reference numerals, and signs are used, and differences from the first embodiment are described.

In the first embodiment described above, consideration is not given to a delay from the target angle δ_{ref} of the steered angle output from the vehicle driving support device 12 until the desired steered angle δₚ is achieved through control of the motor by the steering controller 9. In this case, a delay in transmission and reception of signals between the vehicle driving support device 12 and the steering controller 9 via the network, a response delay of the steering controller 9, and the like actually occur.

Those delays are not considered in the models in the first embodiment, and hence, when the delay is large enough not to be ignored in the actual vehicle, the stability of the system decreases, and the steered angle δ₉ may oscillate. Thus, in the third embodiment, the delay is considered so as to suppress the vibration of the steering wheel, to thereby achieve further smoother automatic steering, which causes further less sense of discomfort.

Specifically, the predictor 41 in Step S3 is different from that of the first embodiment, and is a predictor that considers the delay. On this occasion, a vehicle motion delay caused by the delay from the target angle δ_{ref} to the actual steered angle δₚ is modeled by correcting Expression (9) to Expression (17).

$${B}_{c} = [ \begin{matrix}1 \\ 0 \\ - \frac{2 {K}_{f}}{m} {T}_{delay} \\ 0 \\ - \frac{2 {l}_{f} {K}_{f}}{{I}_{z}} {T}_{delay} \\ 0 \\ \frac{{C}_{tsens}}{{J}_{h}}\end{matrix} ] \qquad ( 17 )$$

This modeling is based on such an idea that the steered angle decreases by an amount

T_{delay}\dot{δ}ₚ

when the delay is T_{delay}.

In the third embodiment, influence of the delay T_{delay} on instability of the control system is large in the vehicle motion, and hence the model of the delay is included in the vehicle motion model. However, the modeling of the delay is not limited to this configuration, and models of the delay may be included in Expression (3) of the steering-shaft motion model and Expression (4).

Moreover, as the modeling of the delay, the delay is modeled as the delay in the steered angle δₚ, but the delay may be modeled as a delay in time of the following steered angular velocity:

\dot{δ}ₚ

Moreover, the model of the delay is not limited to Expression (17), and a steered angle δₚ_{_}_{delay} delayed by steps corresponding to the delay may be applied to δₚ of the vehicle motion model in a discretized state equation as given by Expression (18).

$${δ}_{p \_ delay} = \frac{1}{{z}^{{n}_{delay}}} {δ}_{p} \qquad ( 18 )$$

With the configuration of the third embodiment, the model of the delay is included in the motion model to be used in the predictor 41, and hence u[1] to u[N] calculated by the optimization calculator 45 can be optimal inputs in consideration of the delay.

In other words, inputs to which correction for lead is applied can be calculated in consideration of the delay so as to cancel the delay. As a result, stability of the control system can be improved, and automatic steering that suppresses the vibration, is smooth, and does not cause the sense of discomfort can be achieved.

In the first embodiment to the third embodiment, the vehicle driving support device 12 and the steering control device 9 are the devices independent of each other, but the steered angle controller 52 and the motor driver 53 of the steering control device 9 may be built into the vehicle driving support device 12. In this case, the interposition of the network is not required, and thus a delay due to the network can accordingly be improved.

### Fourth Embodiment

A description is now given of a fourth embodiment of the present invention. Regarding configurations common to the first and fourth embodiments, the same names, reference numerals, and signs are used, and differences from the first embodiment are described.

In the fourth embodiment, the steering-shaft motion model 43 is different from that of the first embodiment, and Expression (19) is additionally used.

$${J}_{p} \frac{{d}^{2} {δ}_{p}}{{d}^{2} t} = {K}_{tsens} ( {δ}_{h} - {δ}_{p} ) + {C}_{tsens} ( \frac{d {δ}_{h}}{dt} - \frac{d {δ}_{p}}{dt} ) + {T}_{motor} - {T}_{align} \qquad ( 19 )$$

In Expression (19), T_{align} is a road-surface-reaction-force torque, and is calculated from the state quantities calculated through Expression (1) and Expression (2). Moreover, Tₘₒₜₒᵣ is a torque generated by the motor, and in this case, is multiplied by the gear ratio of the speed reduction mechanism 7. Moreover, an input u to the model is the torque Tₘₒₜₒᵣ generated by the motor. The current of the motor may also be equivalently used as the input.

A constraint condition can be set to the maximum torque of the motor 6 by inputting the torque Tₘₒₜₒᵣ generated by the motor to the model, the vibration of the steering wheel 1 can be suppressed in a range in which the constraint condition is satisfied, vibration of the steering torque sensor can also be suppressed, the problem of the erroneous determination of the steering intervention by the driver can be prevented, and thus smoother automatic steering causing less sense of discomfort can be achieved.

Moreover, the input to the model is the steered angular velocity in the first embodiment to the third embodiment, and is the motor torque in the fourth embodiment, but a steered angular acceleration, a steered angular jerk, and a change amount in the motor torque may be the input.

In such a case, a smoother vehicle behavior can be achieved by inputting the steered angular acceleration or the steered angular jerk, and adding the steered angular acceleration or the steered angular jerk to the cost function and the constraint condition. Moreover, through input of the change amount of the motor torque and addition of the change amount of the motor torque to the cost function and the constraint condition, a sudden change in motor current can be suppressed, the vibration of the steering wheel can be suppressed, the vibration of the torque sensor can be suppressed, the problem of the erroneous determination of the steering intervention by the driver can be prevented, and thus smoother automatic steering causing less sense of discomfort can be achieved.

### Fifth Embodiment

A description is now given of a fifth embodiment of the present invention. Regarding configurations common to the first and fifth embodiments, the same names, reference numerals, and signs are used, and differences from the first embodiment are described.

In the fifth embodiment, the weights of the respective terms of the cost function J are changed in accordance with the magnitude of the steering torque detected by the steering torque sensor 5. For example, when the detected steering torque is high, and the absolute value of the steering torque is larger than a predetermined value set in advance, a possibility of the steering intervention by the driver is high, and thus the steering intervention by the driver can be prevented from being obstructed by reducing Q_{y} and prioritizing reduction of the steering torque over following of the path.

Moreover, the constraint condition may be changed in accordance with the magnitude of the steering torque detected by the steering torque sensor 5. For example, when the detected steering torque is high, and the absolute value of the steering torque is larger than the predetermined value, the possibility of the steering intervention by the driver, namely, such a possibility that the driver is holding the steering wheel 1, is high, and thus the driver does not feel the sense of discomfort when the behavior of the steering shaft 2 is smooth.

Thus, when the absolute value of the steering torque is higher than the predetermined value, effective ranges of restriction conditions for the steered angular velocity, the steered angular acceleration, the steered angular jerk, and the change amount of the motor torque are reduced. As a result, smoother automatic steering causing less sense of discomfort can be achieved.

Moreover, the motion models to be used in the predictor 41 may be changed in accordance with the magnitude of the steering torque detected by the steering torque sensor 5. For example, when the absolute value of the detected steering torque is larger than the predetermined value, the predictor 41 also uses the steering-shaft motion model for a predetermined period set in advance.

On the other hand, when the absolute value of the detected steering torque is smaller than the predetermined value, the predictor 41 does not use the steering-shaft motion model, and uses only the vehicle motion model. With this configuration, when the detected steering torque is low, the models used by the predictor can be simplified, and the calculation load can thus be reduced.

### Sixth Embodiment

A description is now given of a sixth embodiment of the present invention. Regarding configurations common to the first and sixth embodiments, the same names, reference numerals, and signs are used, and differences from the first embodiment are described.

In the sixth embodiment, the respective state quantities, which are the result of the prediction by the predictor 41 are output to the steering controller 9 via the I/F unit 25 at the predetermined cycle Ts set in advance. The steering controller 9 can acquire the respective state quantities, which are the results predicted by the predictor 41, and thus control parameters of the steering controller 9 and the like can be changed in advance.

For example, a predicted twist amount of the steering shaft 2 occurring during the automatic steering can be recognized from the result of the prediction of the twisted amount by the predictor 41, and thus the threshold for the steering torque to be used for the override function is set to be larger than the predicted twist amount, to thereby be able to preventing unexpected override determination.

The first embodiment to the sixth embodiment can be combined with one another within the technical scopes thereof.

Moreover, as indicated by the second term on the right side of Expression (3), the change in twist amount of the steering shaft 2 may be included in the cost function and the constraint condition, to thereby reduce a predicted value of the change in twist amount of the steering shaft 2 in a predetermined period in the future.

Also with this configuration, the effect of reducing the twist amount of the steering shaft 2 is provided. Thus, the vibration of the steering wheel can be suppressed, and the vibration of the steering torque sensor can be suppressed. Further, the problem of the erroneous determination of the steering intervention by the driver can be prevented, and hence smoother automatic steering causing less sense of discomfort can be achieved.

1: A vehicle driving support device, comprising:
a state acquisition device configured to acquire a detection result from a state detector configured to detect a travel state and a steering state of a vehicle;
a target path information acquisition device configured to acquire target path information indicating a path on which the vehicle is to travel;
a prediction device configured to use a vehicle motion model describing a motion of the vehicle, and a steering-shaft motion model describing a motion of a steering shaft configured to couple a steering wheel and a motor configured to support steering of the vehicle to each other, to thereby predict a deviation of a position of the vehicle from the target path information, and a twist amount of the steering shaft; and
a calculator configured to calculate a target amount of a steering controller configured to control the motor based on the deviation of the position of the vehicle from the target path information and the twist amount of the steering shaft so as to reduce the twist amount of the steering shaft,
wherein the calculator includes:
an evaluator configured to calculate a cost function formed of the deviation of the position of the vehicle from the target path information and the twist amount of the steering shaft, which are predicted by the predictor, or an evaluator configured to calculate a cost function formed of the deviation of the position of the vehicle from the target path information, which is predicted by the predictor, and a constraint condition relating to the twist amount of the steering shaft, which is predicted by the predictor; and
an optimization calculator configured to calculate a steered angle of the steering shaft through convergence calculation using the predictor and the evaluator.

2: A vehicle driving support device according to claim 1,
wherein the evaluator is configured to calculate a cost function formed of the deviation of the position of the vehicle and the twist amount of the steering shaft, which are predicted by the predictor, and
wherein the optimization calculator is configured to calculate a steered angle of the steering shaft, which is at least required to cause the cost function to converge to a value equal to or less than a predetermined value set in advance or a minimum value, through convergence calculation using the predictor and the evaluator.

3: A vehicle driving support device according to claim 2, wherein the cost function or the vehicle motion model and the steering-shaft motion model to be used by the predictor are changed in accordance with a magnitude of a steering torque detected by the state detector.

4: A vehicle driving support device according to claim 1,
wherein the evaluator is configured to calculate a cost function formed of the deviation of the position of the vehicle from the target path information, which is predicted by the predictor, and a constraint condition relating to the twist amount of the steering shaft, which is predicted by the predictor, and
wherein the optimization calculator is configured to calculate a steered angle of the steering shaft, which at least satisfies the constraint condition and is required to cause the cost function to converge to a value equal to or less than a predetermined value set in advance or a minimum value, through convergence calculation using the predictor and the evaluator.

5: A vehicle driving support device according to claim 4, wherein at least one of the cost function, the vehicle motion model and the steering-shaft motion model to be used by the predictor, or the constraint condition is changed in accordance with a magnitude of a steering torque detected by the state detector.

6: A vehicle driving support device according to claim 1, wherein the steering-shaft motion model describing the motion of the steering shaft includes a model configured to receive input of at least one of a steered angle, a steered angular velocity, a steered angular acceleration, or a steered angular jerk to calculate the twist amount of the steering shaft.

7: A vehicle driving support device according to claim 1, wherein the predictor has a model containing a delay from a target value of the steering controller to an actual operation of the motor.

8: A vehicle driving support device according to claim 1, further comprising a target amount output device configured to output the target amount of the steering controller to the steering controller,
wherein the target amount output device is configured to output a prediction result obtained by the predictor to the steering controller.

9: A vehicle driving support method to be achieved by a vehicle driving support device configured to support driving of a vehicle, the vehicle driving support method comprising:
a state acquisition step of acquiring a detection result from a state detection device configured to detect a travel state and a steering state of the vehicle;
a target path information acquisition step of acquiring target path information indicating a path on which the vehicle is to travel;
a prediction step of using a vehicle motion model describing a motion of the vehicle, and a steering-shaft motion model describing a motion of a steering shaft configured to couple a steering wheel and a motor configured to support steering of the vehicle to each other, to thereby predict a deviation of a position of the vehicle from the target path information, and a twist amount of the steering shaft; and
a calculation step of calculating a target amount of a steering controller configured to control the motor based on the deviation of the position of the vehicle from the target path information and the twist amount of the steering shaft so as to reduce the twist amount of the steering shaft,
wherein the calculation step includes:
an evaluation step of calculating a cost function formed of the deviation of the position of the vehicle from the target path information and the twist amount of the steering shaft, which are predicted by the prediction step, or an evaluation step of calculating a cost function formed of the deviation of the position of the vehicle from the target path information, which is predicted by the prediction step, and a constraint condition relating to the twist amount of the steering shaft, which is predicted by the prediction step; and
an optimization step of calculating a steered angle of the steering shaft through convergence calculation using the prediction step and the evaluation step.
